(19) United States
(12) Patent Application Publication
(10) Pub. No.: US 2022/0034433 A1
(43) Pub. Date: Feb. 3, 2022

(54) PIPE JOINT AND METHOD FOR USING SAME

(71) Applicant: HUIZHOU HYDRO CARESYS MEDICAL CO., LTD., Huizhou, Guangdong (CN)

(72) Inventors: Yan Wu, Huizhou, Guangdong (CN); Guangyu Sun, Huizhou, Guangdong (CN)

(21) Appl. No.: 17/278,653

(22) PCT Filed: Dec. 28, 2018
(86) PCT No.: PCT/CN2018/125113

§ 371 Date: Mar. 22, 2021

(30) Foreign Application Priority Data
Sep. 21, 2018 (CN) 201811104432.1

(51) Int. Cl. F16L 13/02; F16L 15/00; F16L 33/207

(52) U.S. Cl. CPC F16L 13/0209; F16L 33/2076; F16L 15/006

(57) ABSTRACT

A pipe joint and a method for using the same are provided. The pipe joint comprises a joint body within which a cavity channel and an outer hole channel are provided, the cavity channel forms a first outer insertion opening for insertion of a flexible pipe and a second outer insertion opening for insertion of a rigid pipe; an inner hole channel is further communicated between the cavity channel and the outer hole channel, which forms an inner insertion opening; an liner pipe is provided in the cavity channel, one end of the liner pipe is inserted into the inner hole channel, and the other end of the liner pipe is provided with a connection section which is provided with at least one bulging part. The pipe joint in the invention improves the connection stability between a flexible pipe and a rigid pipe.

### TECHNICAL FIELD

The invention relates to the technical field of pipeline connection, in particular to a pipe joint and a method for using the same.

### BACKGROUND

At present, flexible pipes and rigid pipes are often connected with specially made steel-plastic conversion joints so as to achieve their respective homogeneous connections. The connections can be homogeneous welding, threaded connections and so on. In order to prevent the joints from loosening, there are two types of joints in the prior art: one is a new type of shell-type steel-plastic joint in which a bushing inserted into a flexible pipe is provided with inverted teeth, the other is micro flow high-pressure fluid pipe joint which is sealed and connected by adding a sealing ring and a threaded sleeve.

However, the above two types of joints have many shortcomings: special joint fittings need to be manufactured with special molds, which increases costs; and the flexible pipe may become concave during insertion of the bushing with inverted teeth or in the process of screwing the threaded sleeve, which causes the internal flow channel narrowed, leading to deformation of the fluid passing through and loss of energy. The inward concave of the flexible pipe is more obvious especially when the bushing or threaded sleeve is thin-walled. These shortcomings all limit normal use of connection between flexible pipes and rigid pipes.

### SUMMARY

In order to solve the aforementioned technical problems, a pipe joint and a method for using the same are provided in the invention. The pipe joint improves stability of the connection between a flexible pipe and a rigid pipe, and also solves the problem that an internal flow channel is narrowed due to inward concave of the flexible pipe; in addition, the pipe joint has a simple structure and low manufacturing cost, and is easy to use.

Based on this, a pipe joint provided in the invention comprises a joint body within which a cavity channel and an outer hole channel are provided, the cavity channel is formed at one end of the joint body a first outer insertion opening for insertion of a flexible pipe to be connected, and the outer hole channel is formed at the other end of the joint body a second outer insertion opening for insertion of a rigid pipe to be connected;

an inner hole channel is further communicated between the cavity channel and the outer hole channel, the inner hole channel forms an inner insertion opening at an innermost end of the cavity channel and forms a communication opening at an innermost end of the outer hole channel; an liner pipe is provided in the cavity channel, one end of the liner pipe is inserted into the inner hole channel through the insertion opening, the other end of the liner pipe is provided with a connection section to be inserted into the flexible pipe, and the connection section is provided with at least one bulging part.

In a preferred embodiment, a filter screen is provided at the communication opening.

In a preferred embodiment, the outer hole channel is a threaded hole.

In a preferred embodiment, a length of the liner pipe other than the connecting section is in a range from 0.1 to 50 mm.

In a preferred embodiment, the flexible pipe is a high-pressure braided pipe including three layers, the inner and outer layers are plastic pipes, and the intermediate layer is a braided mesh pipe.

In a preferred embodiment, the rigid pipe is a metal pipe.

The invention also provides a method for using a pipe joint above, which comprises the following steps:

Step 1: inserting a connecting section of a liner pipe into a flexible pipe;

Step 2: inserting the flexible pipe and the liner pipe together into a cavity channel of a joint body from a first outer insertion opening, and at the same time inserting an end of the liner pipe outside the flexible pipe into an inner hole channel of the joint body from an inner insertion opening;

Step 3: squeezing to deform the joint body, and compressing the flexible pipe so that an outer wall of the flexible pipe closely contacts with a side wall of the cavity channel; and

Step 4: inserting a rigid pipe into an outer hole channel of the joint body from a second outer insertion opening, and then fixing the rigid pipe by circumferential welding to complete connection of the rigid pipe and the flexible pipe.

Implementing the embodiments of the present invention has the following beneficial effects:

The pipe joint provided in the invention comprises a joint body within which a cavity channel and an outer hole channel are provided, the cavity channel forms at one end of the joint body a first outer insertion opening for insertion of a flexible pipe to be connected, the outer hole channel forms at the other end of the joint body a second outer insertion opening for insertion of a rigid pipe to be connected; an inner hole channel is further communicated between the cavity channel and the outer hole channel, the inner hole channel forms an inner insertion opening at an innermost end of the cavity channel and forms a communication opening at an innermost end of the outer hole channel; an liner pipe is provided in the cavity channel, one end of the liner pipe is inserted into the inner hole channel through the inner insertion opening, and the other end of the liner pipe is provided with a connection section to be inserted into the flexible pipe, and the connection section is provided with at least one bulging part. With such configuration, the bulging part inserted into the flexible pipe can squeeze the pipe wall of the flexible pipe to make it closely contact with the side wall of the cavity channel, thereby realizing a stable and sealed connection between the flexible pipe and the rigid pipe; at the same time, the liner pipe also has the function of supporting the flow channel, which can ensure that the flexible pipe inserted into the cavity channel will not be concave and deformed, thereby solving the problem of narrowed internal flow channel and ensuring smoothness of the internal flow channel. Further, the energy lost when the fluid passes through can be reduced, and the ability of the pipe joint to withstand ultra-high pressure can be improved. In addition, the pipe joint provided in the invention has the advantages of simple structure, low production cost, convenient use, and the like.

A method for using a pipe joint above provided in the invention has the advantages of being simple, convenient and easy to implement.

### BRIEF DESCRIPTION OF DRAWINGS

FIG. 1 is a schematic cross-sectional structure diagram of a pipe joint according to an embodiment of the invention; and

FIG. 2 is a structural diagram showing how to use a pipe joint according an embodiment of the invention.

### LIST OF REFERENCE NUMERALS

1, joint body; 11, cavity channel; 12, outer hole channel; 13, first outer insertion opening; 14, second outer insertion opening; 15, inner hole channel; 16, inner insertion opening; 17, communication opening; 18, filter screen; 2, flexible pipe; 3, rigid pipe; 4, liner pipe; and 41, bulging part.

### DETAILED DESCRIPTION

Hereafter, the technical solutions in embodiments of the invention will be described clearly and completely in conjunction with the accompanying drawings in the embodiments of the invention. Obviously, the described embodiments are only a part of the embodiments of the invention, rather than all the embodiments. Based on the embodiments of the invention, all other embodiments obtained by those of ordinary skill in the art without creative work shall fall within the protection scope of the invention.

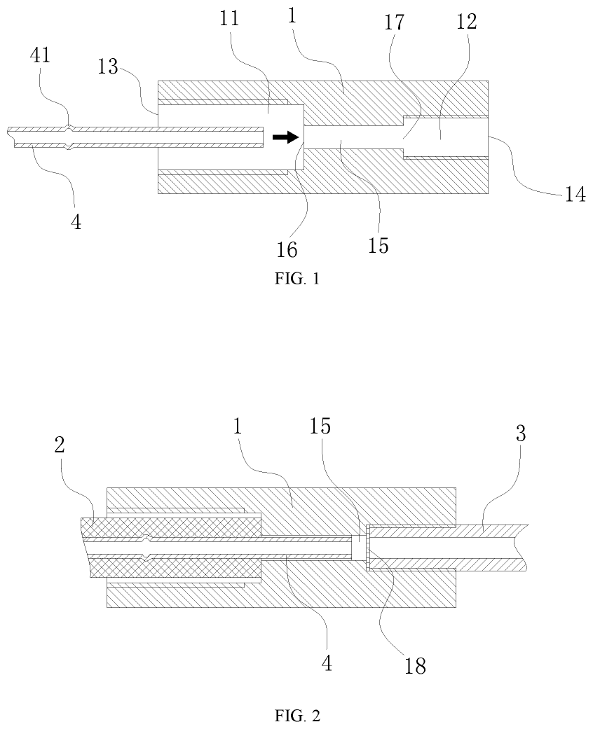

Refer to FIGS. 1 and 2. A pipe joint provided according to an embodiment of the invention comprises a joint body 1 within which a cavity channel 11 and an outer hole channel 12 are provided. The cavity channel 11 forms at one end of the joint body 1 a first outer insertion opening 13 for insertion of a flexible pipe 2 to be connected, and the outer hole channel 12 forms at the other end of the joint body 1 a second outer insertion opening 14 for insertion of a rigid pipe 3 to be connected. An inner hole channel 15 is further communicated between the cavity channel 11 and the outer hole channel 12. The inner hole channel 15 forms an inner insertion opening 16 at an innermost end of the cavity channel 11, and forms a communication opening 17 at an innermost end of the outer hole channel 12. A liner pipe 14 difficult to deform, such as a metal pipe, is provided in the cavity channel 11. One end of the liner pipe 4 is inserted into the inner hole channel 15 through the inner insertion opening 16, and the other end of the liner pipe 4 is provided with a connection section to be inserted into the flexible pipe 2. The connection section is provided with at least one bulging part 41. A length of the liner pipe 4 other than the connecting section is in a range from 0.1 to 50 mm.

With such configuration, the bulging part 41 inserted into the flexible pipe 2 can squeeze the pipe wall of the flexible pipe 2 to make it closely contact with the side wall of the cavity channel 11, thereby realizing a stable and sealed connection between the flexible pipe 2 and the rigid pipe 3; at the same time, the liner pipe 4 also has the function of supporting the flow channel, which can ensure that the flexible pipe 2 inserted into the cavity channel 11 will not be concave and deformed, thereby solving the problem of narrowed internal flow channel and ensuring unobstructed internal flow channel. Further, the energy lost when the fluid passes through can be reduced, and the ability of the pipe joint to withstand ultra-high pressure can be improved.

Further, as shown in FIGS. 1 to 2, since an end of the flexible pipe 2 may be deformed during insertion into the cavity channel 11 and tiny particles will fall off the flexible pipe 2, a filter screen 18 is provided at the communication opening, which has a mesh range of 4 to 400 mesh. The filter screen 18 can filter the fluid flowing through the pipe joint to avoid the problem of bursting of the pipe joint due to blockage of tiny particles. In addition, in order to ensure stability of the connection between the rigid pipe 3 and the joint body 1, the outer hole channel 12 is a threaded hole with thread that can be English standard pipe thread (R), metric pipe thread (ZM or M), or national (American) pipe thread (NPT or NPSC).

It should be pointed out that the flexible pipe 2 to be connected in the embodiment of the invention refers to a high-pressure braided pipe which is mainly composed of plastic pipes and a braided mesh pipe. Specifically, the high-pressure braided pipe includes three layers, the inner and outer layers are plastic pipes, and the intermediate layer is a braided mesh pipe. The braided mesh pipe, which is made of environmentally friendly materials, has features of good abrasion resistance, expandability, smoothness, high pressure resistance, flame retardancy and ventilation and heat dissipation. In addition, the rigid pipe 3 to be connected in the embodiment of the present invention refers to a metal pipe.

A method for using a pipe joint above is also provided according to an embodiment of the invention, which comprises the following steps:

Step 1: inserting a connecting section of a liner pipe 4 into a flexible pipe 2;

Step 2: inserting the flexible pipe 2 and the liner pipe 4 together into a cavity channel 11 of a joint body 1 from a first outer insertion opening 13, and at the same time inserting an end of the liner pipe 4 outside the flexible pipe 2 into an inner hole channel 15 of the joint body 1 from an inner insertion opening 16;

Step 3: squeezing to deform the joint body 1, and compressing the flexible pipe 2 so that an outer wall of the flexible pipe 2 closely contacts with a side wall of the cavity channel 11; and

Step 4: inserting a rigid pipe 3 with external thread into an outer hole channel 12 of the joint body 1 from a second outer insertion opening 14, and then fixing the rigid pipe 3 by circumferential welding to complete connection of the rigid pipe 3 and the flexible pipe 2.

In summary, a pipe joint is provided in the invention, which comprises a joint body 1 within which a cavity channel 11 and an outer hole channel 12 are provided. The cavity channel 11 forms at one end of the joint body 1 a first outer insertion opening 13 for insertion of a flexible pipe 2 to be connected, and the outer hole channel 12 forms at the other end of the joint body 1 a second outer insertion opening 14 for insertion of a rigid pipe 3 to be connected. An inner hole channel 15 is further communicated between the cavity channel 11 and the outer hole channel 12. The inner hole channel 15 forms an inner insertion opening 16 at an innermost end of the cavity channel 11, and forms a communication opening 17 at an innermost end of the outer hole channel 12. A liner pipe 14 is provided in the cavity channel 11. One end of the liner pipe 4 is inserted into the inner hole channel 15 through the inner insertion opening 16, and the other end of the liner pipe 4 is provided with a connection section to be inserted into the flexible pipe 2. The connection section is provided with at least one bulging part 41. Compared with pipe joints in the prior art, the pipe joint in the invention has the following technical effects:

1. The stability of the connection between the flexible pipe 2 and the rigid pipe 3 is improved, and the problem of narrowed internal flow channel due to inward concave of the flexible pipe 2 is solved;

2. The filter screen 18 can prevent the pipe joint from bursting due to blockage of tiny particles; and

3. The pipe joint provided in the invention has advantages of simple structure, low production cost, and convenient use.

In addition, the method for using a pipe joint above provided in the invention has the advantages of being simple, convenient and easy to implement.

It should be understood that the terms “first”, “second”, etc. are used in the present invention to describe various information, but the information should not be limited to these terms. These terms are only used to distinguish the same type of information from each other. For example, without departing from the scope of the present invention, “first” information may also be referred to as “second” information, and similarly, “second” information may also be referred to as “first” information.

The above are only the preferred embodiments of the present invention. It should be pointed out that for those of ordinary skill in the art, several improvements and substitutions can be made without departing from the technical principle of the present invention, which improvements and substitutions should also fall within the protection scope of the present invention.

1. A pipe joint, wherein the pipe joint comprises a joint body within which a cavity channel and an outer hole channel are provided, the cavity channel forming at one end of the joint body a first outer insertion opening for insertion of a flexible pipe to be connected, and the outer hole channel forming at the other end of the joint body a second outer insertion opening for insertion of a rigid pipe to be connected;
an inner hole channel is further communicated between the cavity channel and the outer hole channel, the inner hole channel forming an inner insertion opening at an innermost end of the cavity channel and forming a communication opening at an innermost end of the outer hole channel; an liner pipe being provided in the cavity channel, one end of the liner pipe being inserted into the inner hole channel through the inner insertion opening, the other end of the liner pipe being provided with a connection section to be inserted into the flexible pipe, and the connection section being provided with at least one bulging part.

2. The pipe joint of claim 1, wherein a filter screen is provided at the communication opening.

3. The pipe joint of claim 1, wherein the outer hole channel is a threaded hole.

4. The pipe joint of claim 1, wherein a length of the liner pipe other than the connecting section is in a range from 0.1 to 50 mm.

5. The pipe joint of claim 1, wherein the flexible pipe is a high-pressure braided pipe including three layers, the inner and outer layers are plastic pipes, and the intermediate layer is a braided mesh pipe.

6. The pipe joint of claim 1, wherein the rigid pipe is a metal pipe.

7. A method for using a pipe joint of claim 1, wherein the method comprises following steps:
Step 1: inserting a connecting section of a liner pipe into a flexible pipe;
Step 2: inserting the flexible pipe and the liner pipe together into a cavity channel of a joint body from a first outer insertion opening, and at the same time inserting an end of the liner pipe outside the flexible pipe into an inner hole channel of the joint body from an inner insertion opening;
Step 3: squeezing to deform the joint body, and compressing the flexible pipe so that an outer wall of the flexible pipe closely contacts with a side wall of the cavity channel; and
Step 4: inserting a rigid pipe into an outer hole channel of the joint body from a second outer insertion opening, and then fixing the rigid pipe by circumferential welding to complete connection of the rigid pipe and the flexible pipe.

8. A method for using a pipe joint of claim 2, wherein the method comprises following steps:
Step 1: inserting a connecting section of a liner pipe into a flexible pipe;
Step 2: inserting the flexible pipe and the liner pipe together into a cavity channel of a joint body from a first outer insertion opening, and at the same time inserting an end of the liner pipe outside the flexible pipe into an inner hole channel of the joint body from an inner insertion opening;
Step 3: squeezing to deform the joint body, and compressing the flexible pipe so that an outer wall of the flexible pipe closely contacts with a side wall of the cavity channel; and
Step 4: inserting a rigid pipe into an outer hole channel of the joint body from a second outer insertion opening, and then fixing the rigid pipe by circumferential welding to complete connection of the rigid pipe and the flexible pipe.

9. A method for using a pipe joint of claim 3, wherein the method comprises following steps:
Step 1: inserting a connecting section of a liner pipe into a flexible pipe;
Step 2: inserting the flexible pipe and the liner pipe together into a cavity channel of a joint body from a first outer insertion opening, and at the same time inserting an end of the liner pipe outside the flexible pipe into an inner hole channel of the joint body from an inner insertion opening;
Step 3: squeezing to deform the joint body, and compressing the flexible pipe so that an outer wall of the flexible pipe closely contacts with a side wall of the cavity channel; and
Step 4: inserting a rigid pipe into an outer hole channel of the joint body from a second outer insertion opening, and then fixing the rigid pipe by circumferential welding to complete connection of the rigid pipe and the flexible pipe.

10. A method for using a pipe joint of claim 4, wherein the method comprises following steps:
Step 1: inserting a connecting section of a liner pipe into a flexible pipe;
Step 2: inserting the flexible pipe and the liner pipe together into a cavity channel of a joint body from a first outer insertion opening, and at the same time inserting an end of the liner pipe outside the flexible pipe into an inner hole channel of the joint body from an inner insertion opening;
Step 3: squeezing to deform the joint body, and compressing the flexible pipe so that an outer wall of the flexible pipe closely contacts with a side wall of the cavity channel; and
Step 4: inserting a rigid pipe into an outer hole channel of the joint body from a second outer insertion opening, and then fixing the rigid pipe by circumferential welding to complete connection of the rigid pipe and the flexible pipe.

11. A method for using a pipe joint of claim 5, wherein the method comprises following steps:
Step 1: inserting a connecting section of a liner pipe into a flexible pipe;
Step 2: inserting the flexible pipe and the liner pipe together into a cavity channel of a joint body from a first outer insertion opening, and at the same time inserting an end of the liner pipe outside the flexible pipe into an inner hole channel of the joint body from an inner insertion opening;
Step 3: squeezing to deform the joint body, and compressing the flexible pipe so that an outer wall of the flexible pipe closely contacts with a side wall of the cavity channel; and
Step 4: inserting a rigid pipe into an outer hole channel of the joint body from a second outer insertion opening, and then fixing the rigid pipe by circumferential welding to complete connection of the rigid pipe and the flexible pipe.

12. A method for using a pipe joint of claim 6, wherein the method comprises following steps:
Step 1: inserting a connecting section of a liner pipe into a flexible pipe;
Step 2: inserting the flexible pipe and the liner pipe together into a cavity channel of a joint body from a first outer insertion opening, and at the same time inserting an end of the liner pipe outside the flexible pipe into an inner hole channel of the joint body from an inner insertion opening;
Step 3: squeezing to deform the joint body, and compressing the flexible pipe so that an outer wall of the flexible pipe closely contacts with a side wall of the cavity channel; and
Step 4: inserting a rigid pipe into an outer hole channel of the joint body from a second outer insertion opening, and then fixing the rigid pipe by circumferential welding to complete connection of the rigid pipe and the flexible pipe.
